(19) United States
(12) Patent Application Publication
(10) Pub. No.: US 2025/0246988 A1
(43) Pub. Date: Jul. 31, 2025

(54) POWER SUPPLY CIRCUIT, CONTROL METHOD, CHIP, AND ELECTRONIC DEVICE

(71) Applicant: Smarter Silicon (Shanghai) Technologies Co., Ltd., Shanghai (CN)

(72) Inventors: Hongyu SUN, Shanghai (CN); Wei LI, Shanghai (CN)

(21) Appl. No.: 19/032,111

(22) Filed: Jan. 19, 2025

(30) Foreign Application Priority Data
Jan. 31, 2024 (CN) 202410139958.2

(51) Int. Cl. H02M 1/00

(52) U.S. Cl. CPC H02M 1/009; H02M 1/0009; H02M 1/0025

(57) ABSTRACT

A power supply circuit includes a power supply module and a controller. The power supply module includes a plurality of output branches configured to control a working state of each of the plurality of output branches according to a load, to provide a suitable driving signal. The controller is connected to the power supply module and configured to control the power supply module to adjust an output voltage when a sampling signal provided by the power supply module meets a set condition. The set condition is related to a switching condition of the power supply module switching from a first state to a second state.

### CROSS-REFERENCE TO RELATED APPLICATION

This application claims priority to Chinese Patent Application No. 202410139958.2, filed on Jan. 31, 2024, the entire content of which is incorporated herein by reference.

### TECHNICAL FIELD

The present disclosure generally relates to the field of electronic technologies and, more particularly, to a power supply circuit and control method, a chip including the power supply circuit, and an electronic device including the chip.

### BACKGROUND

With the development of electronic technology, the current demand of modules such as a CPU (central processing unit), a GPU (graphic processing unit), or an NPU (neural-network processing unit) in system-level chips is increasing. Therefore, a multi-phase buck power supply circuit is usually used for power supply in the power supply design of system-level chips. However, the existing equipment powered by the multi-phase buck power supply circuit will have system abnormalities during operation.

### SUMMARY

One aspect of the present disclosure provides a power supply circuit including a power supply module and a controller. The power supply module includes a plurality of output branches, and is configured to control a working state of each of the plurality of output branches according to a load, to provide a suitable driving signal. The controller is connected to the power supply module, and is configured to control the power supply module to adjust an output voltage when a sampling signal provided by the power supply module meets a set condition. The set condition is related to a switching condition of the power supply module switching from a first state to a second state.

Another aspect of the present disclosure provides a control method of a power supply circuit, including: obtaining a sampling signal of a power supply module in the power supply circuit; and controlling the power supply module to adjust an output voltage when the sampling signal provided by the power supply module meets a set condition, where the set condition is related to a switching condition of the power supply module switching from a first state to a second state.

Another aspect of the present disclosure provides a chip including a power supply circuit. The power supply circuit includes a power supply module and a controller. The power supply module includes a plurality of output branches, and is configured to control a working state of each of the plurality of output branches according to a load, to provide a suitable driving signal. The controller is connected to the power supply module, and is configured to control the power supply module to adjust an output voltage when a sampling signal provided by the power supply module meets a set condition. The set condition is related to a switching condition of the power supply module switching from a first state to a second state.

Another aspect of the present disclosure provides an electronic device including a chip. The chip includes a power supply circuit. The power supply circuit includes a power supply module and a controller. The power supply module includes a plurality of output branches configured to control a working state of each of the plurality of output branches according to a load, to provide a suitable driving signal. The controller is connected to the power supply module and is configured to control the power supply module to adjust an output voltage when a sampling signal provided by the power supply module meets a set condition. The set condition is related to a switching condition of the power supply module switching from a first state to a second state.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those ordinary in the art, other drawings can be obtained based on these drawings without any creative work.

The structures, proportions, sizes, etc. illustrated in the drawings of the present disclosure are only used to match the contents disclosed in the present disclosure to facilitate understanding and reading by persons familiar with this technology. They are not used to limit the conditions under which the present disclosure can be implemented, and therefore have no substantive technical significance. Any structural modification, change in proportion, or adjustment of size, without affecting the effects and purposes that can be achieved by the present disclosure, should still fall within the scope of the technical contents of the present disclosure.

FIG. 1 illustrates a schematic diagram of load current change curve and the corresponding output voltage change curve during the operation of a power supply circuit.

FIG. 2 illustrates a schematic structural diagram of a power supply circuit consistent with embodiments of the present disclosure.

FIG. 3 illustrates a schematic structural diagram of a power supply module in a power supply circuit consistent with embodiments of the present disclosure.

FIG. 4 illustrates a schematic structural diagram of another power supply circuit consistent with embodiments of the present disclosure.

FIG. 5 illustrates a schematic diagram of a load current and its corresponding output voltage change curve during the operation of a power supply circuit consistent with embodiments of the present disclosure.

FIG. 6 illustrates a schematic structural diagram of another power supply circuit consistent with embodiments of the present disclosure.

FIG. 7 illustrates another schematic diagram of a load current and its corresponding output voltage change curve during the operation of a power supply circuit consistent with embodiments of the present disclosure.

FIG. 8 illustrates a schematic structural diagram of another power supply circuit consistent with embodiments of the present disclosure.

FIG. 9 illustrates a flowchart of a control method consistent with embodiments of the present disclosure.

FIG. 10 illustrates a flowchart of another control method consistent with embodiments of the present disclosure.

### DETAILED DESCRIPTION OF THE EMBODIMENTS

The following will be combined with the drawings in the embodiments of the present disclosure to clearly and completely describe the embodiments in the present disclosure. Obviously, the described embodiments are only part of the embodiments of the present disclosure, but not all of the embodiments. Based on the embodiments in the present disclosure, all other embodiments obtained by those skilled in the art without making creative work are within the scope of the present disclosure

Without departing from the spirit or scope of the present disclosure, various modifications and changes can be made in the present disclosure, which is obvious to those skilled in the art. Therefore, the present disclosure is intended to cover the modifications and changes of the present disclosure that fall within the scope of the corresponding claims (technical solutions claimed for protection) and their equivalents. It should be noted that the implementation methods provided in the embodiments of the present disclosure can be combined with each other without contradiction.

To make the above-mentioned purposes, features and advantages of the present disclosure more obvious and easy to understand, the present disclosure is further described in detail below in conjunction with the drawings and specific implementation methods.

As described in the background technology section, the existing equipment powered by a multi-phase buck power supply circuit may experience system abnormalities during operation.

One reason why the existing equipment powered by the multi-phase buck power supply circuit may experience system abnormalities during operation is that the multi-phase buck power supply circuit may experience a large instantaneous voltage change during operation, which may cause system abnormalities.

The phenomenon of large instantaneous voltage changes in the multi-phase buck power supply circuit during operation generally occurs during the stage of switching the working states. For example, when the load of the power supply circuit is small, the output drive current is also small. When the load of the power supply circuit is large, the output drive current is also large. When the load of the power supply circuit is switched from a small load to a large load, the drive current provided by it also needs to be switched from a small drive current to a large drive current. When the load of the power supply circuit is switched from a large load to a small load, the drive current provided by it also needs to be switched from a large drive current to a small drive current.

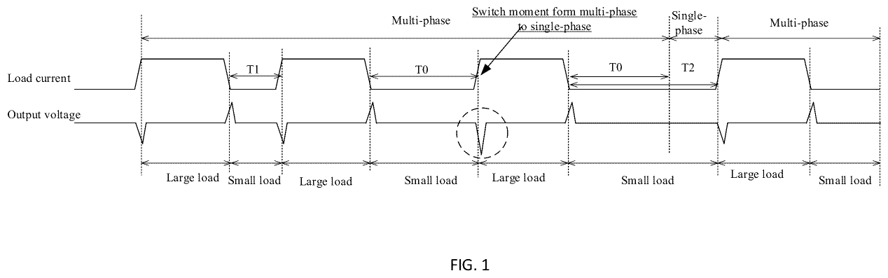

As shown in FIG. 1, which shows a schematic diagram of the change of the load current and the corresponding output voltage change curve during the operation of the power supply circuit, when the current required by the load electrically connected to the output terminal of the power supply circuit increases, the output voltage at the output terminal of the power supply circuit drops (undershoots) corresponding to the rising edge of the load current in FIG. 1. When the current required by the load electrically connected to the output terminal of the power supply circuit decreases, the output voltage at the output terminal of the power supply circuit increases (overshoots) corresponding to the falling edge of the load current in FIG. 1.

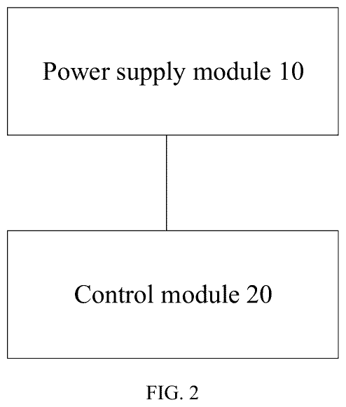

The present disclosure provides a power supply circuit. As shown in FIG. 2, in one embodiment, the power supply circuit includes: a power supply module 10 including multiple output branches, configured to control the working state of each output branch according to the corresponding load to provide a suitable drive signal to drive the load to work; and

a controller 20, connected to the power supply module 10 and configured to control the power supply module 10 to adjust the output voltage when the sampling signal provided by the power supply module 10 meets the set condition, where the set condition is related to the switching condition of the power supply module 10 switching from the first state to the second state.

The output terminal of the power supply module may be the output terminal of the power supply circuit, and the output voltage of the power supply module may be the output voltage of the power supply circuit. The multiple output branches may be electrically connected to the output terminal of the power supply module, and the load may also be electrically connected to the output terminal of the power supply module. The drive current provided to the load by the power supply module may be the sum of the currents output by the multiple output branches.

The power supply circuit provided by the embodiment of the present disclosure may control the power supply module to adjust the output voltage based on the set conditions related to the switching condition of the power supply module switching from the first state to the second state. Therefore, when the power supply module switches from the first state to the second state, the output voltage of the power supply module may change less, avoiding the phenomenon of large instantaneous voltage changes in the output voltage of the power supply module, improving the stability of the output voltage of the power supply circuit, and thus reducing the probability of system abnormalities in the device powered by the power supply circuit when working.

In one embodiment, in the power supply circuit, the controller may control the power supply module to increase the output voltage when the current required by the load increases to reduce the drop amplitude of the output voltage of the power supply module, and control the power supply module to reduce the output voltage when the current required by the load decreases to reduce the increase amplitude of the output voltage of the power supply module, thereby reducing the amplitude of the change of the output voltage during the operation of the power supply module, improving the stability of the output voltage of the power supply module, and thus reducing the probability of system abnormalities in the device powered by the power supply circuit when working.

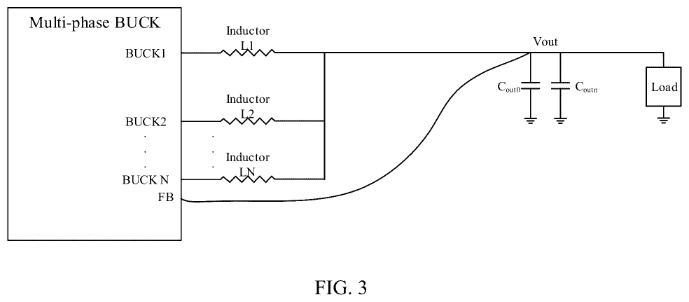

As shown in FIG. 3, the power supply module (multi-phase BUCK) has multiple internal output ports, and the power supply module has multiple power supply units inside, each of which uses one corresponding internal output port as the output terminal, such as BUCK1, BUCK2 . . . . BUCKN. Each internal output port is connected to the output terminal Vout of the power supply module through an inductor branch (such as L1, L2 . . . . Ln), and the output terminal Vout of the power supply module is also grounded through multiple parallel output capacitors (such as Cout1, Cout2 . . . . Coutn). During operation, the output terminal Vout of the power supply module may be connected to a load to provide a drive signal to the load. One inductor branch and its corresponding output port may correspond to one output branch.

During operation, the working state of each output branch may be adjusted in real time based on the load size of the supply voltage. For example, when the current required by the load is small, the number of output branches in the working state in the power supply module may be small. When the current required by the load is large, the number of output branches in the working state in the power supply module may be large. When at least two output branches in the power supply module are in the working state, the power supply module may be in a multi-phase working state. When only one output branch in the power supply module is in working state, the power supply module may be in a single-phase working state. For the convenience of description, in the present disclosure, a load corresponding to the large current required by the load of the power supply circuit is referred to as a large load, and a load corresponding to the small current required by the load of the power supply circuit is referred to as a small load. The specific threshold current for distinguishing large load and small load may be configured according to specific needs.

When the load of the power supply module is switched from small load to large load, the current required by the load of the power supply module may increase, and the controller may need to control the power supply module to switch the working state, for example, from the single-phase state to the multi-phase state, and the working state switching of the power supply module may require a certain amount of time. In this process, the current output by the power supply module may not meet the load demand. Therefore, the output capacitor electrically connected to the output terminal of the power supply module may release the power to provide auxiliary current, and the auxiliary current and the current output by the power supply module may together provide the drive current for the load. As the output capacitor releases its charge, the voltage at the end of the output capacitor connected to the output terminal of the power supply module may decrease, and accordingly, the voltage at the output terminal of the power supply module may also decrease. The duration of the output capacitor releasing its charge may directly determine the voltage drop at the output terminal of the power supply module.

Similarly, when the load of the power supply module is switched from the large load to the small load, the current required by the load of the power supply module may decrease. The controller may need to control the power supply module to switch the working state, for example, from the multi-phase state to the single-phase state, and the working state switching of the power supply module may require a certain amount of time. In this process, the current output by the power supply module may be larger than the current required by the load, and the excess current may flow into the output capacitor to charge the output capacitor, thereby increasing the voltage at the end of the output capacitor connected to the output terminal of the power supply module. Correspondingly, the voltage at the output terminal of the power supply module may also increase. The duration of the output capacitor charging may directly determine the increase in the voltage at the output terminal of the power supply module.

When the load of the power supply circuit is switched from the large load to the small load, and the output voltage provided by the power supply circuit is switched from a large current to a small current, the number of the buck units participating in providing the drive signal may be reduced, the switching time may be shorter, the output voltage of the power supply circuit may increase less, and the probability of causing system abnormality may be smaller.

When the load of the power supply circuit is switched from a small load to a large load, the output voltage provided by the power supply circuit may need to be switched from a small current to a large current. During the multiple moments when the output voltage provided by the power supply circuit needs to be switched from a small current to a large current, the number of buck units involved in the work may need to be increased. The turn-on rate of the buck unit may be lower than the turn-off rate, and the number of buck units cannot be increased in time to respond to the demand for voltage increase in time. Therefore, for at least one moment, the output voltage drop of the power supply circuit may be large, as shown in the dotted box in FIG. 1, and the probability of causing system abnormality may be high. At the position shown in the dotted box in FIG. 1, the load current is originally small. When a large load current demand is encountered, the process of switching from the multi-phase mode to the single-phase mode may be triggered at the same time as the large load current, and the transient drop of the power supply output voltage may be particularly large. When a transient occurs at this moment, since the internal single-phase switching process is not yet finished, the loop response speed may be slow, and the transient drop may be maximum.

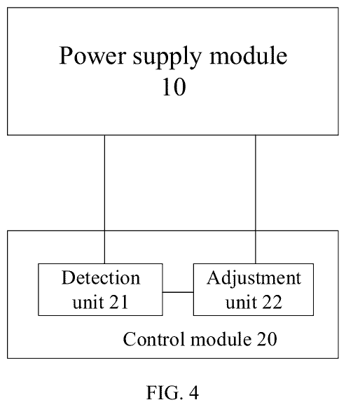

In one embodiment, as shown in FIG. 4, the controller 20 includes:
a detection unit 21, configured to obtain a first sampling signal of the power supply module 10 and output a first detection signal when the first sampling signal meets a first set condition, where the first sampling signal is related to the output current of the power supply module 10; and
an adjustment unit 22, configured to control the power supply module 10 to increase the output voltage when receiving the first detection signal.

In the power supply circuit provided in the embodiment of the present disclosure, the controller may control the power supply module to increase the output voltage based on the first sampling signal related to the output current of the power supply module. Therefore, when the output current provided by the power supply circuit needs to be switched from a small current to a large current, the drop amplitude of the output voltage of the power supply circuit may be reduced, the probability of the drop of the output voltage of the power supply circuit causing system abnormality may be reduced, the stability of the system operation may be improved, and the adjustment frequency of the output voltage of the power supply module may be reduced.

In one embodiment of the present disclosure, the first sampling signal may be the output current of the power supply module, the first set condition may be that the first sampling signal is less than the first current, and the first current may be the threshold current when the power supply module switches from the first state to the second state (for example, from the multi-phase state to the single-phase state). Therefore, when the output current of the power supply module is less than the threshold current when the power supply module switches from the first state to the second state, the controller may control the power supply module to increase the output voltage, reducing the adjustment frequency of the output voltage of the power supply module and the power consumption of the power supply module. Therefore, the adjustment frequency of the output voltage of the power supply module and the power consumption of the power supply circuit may be reduced on the basis of reducing the probability of system abnormality caused by the drop of the output voltage of the power supply module.

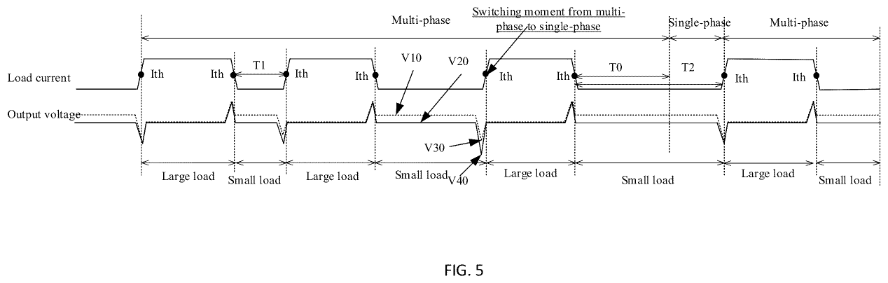

As shown in FIG. 5, which is a schematic diagram of the change of load current and the corresponding output voltage change curve during the operation of the power supply circuit, in one embodiment, T0 is the critical time for the power supply module to switch from the multi-phase working state to the single-phase working state, that is, the time required for the power supply module to complete the process of switching from the multi-phase working state to the single-phase working state is T0, where T1<T0<T2. The dotted line waveform in FIG. 5 is a schematic diagram of the output voltage of the power supply circuit provided by present disclosure and the solid line waveform is a schematic diagram of the output voltage of a power supply circuit in existing technologies.

In FIG. 5, when the load current of the power supply module is less than the threshold current Iₜₕ for switching from the multi-phase state to the single-phase state, the controller may control the power supply module to increase the output voltage. When the load current of the power supply module is not less than the threshold current Iₜₕ for switching from the multi-phase state to the single-phase state, the controller may no longer control the power supply module to increase the output voltage. For convenience of description, the voltage after the controller controls the power supply module to increase the output voltage is recorded as the first voltage V10, and the voltage when the controller does not control the power supply module to increase the output voltage is recorded as the second voltage V20. When the load of the power supply module increases, the voltage of the power supply module after the drop is the third voltage V30. When the controller does not control the power supply module to increase the output voltage and when the load of the power supply module increases, the voltage of the power supply module after the drop is V40.

As can be seen from FIG. 5, when the load of the power supply module increases, the voltage V30 of the power supply module after it drops from V10 is larger than the voltage V40 of the power supply module before the output voltage of the power supply module increases. The difference between the output voltage V30 after the output voltage V10 drops after the increase and the output voltage V20 before the increase may be reduced, that is, the difference between the second voltage V20 and the third voltage V30 may be reduced, thereby reducing the amplitude of the change of the output voltage of the power supply module, improving the stability of the output voltage of the power supply module, and reducing the probability of the system abnormality caused by the large amplitude of the output voltage of the power supply module.

The power supply circuit provided in the embodiment of the present disclosure may effectively alleviate the probability of the system abnormality caused by the drop of the output voltage of the power supply circuit because of the drop of the output voltage of the power supply circuit, and improve the stability of the system operation.

In one embodiment, as shown in FIG. 5, the detection unit includes a first component 21, and the adjustment unit includes a third component 23. The first component 21 may output a first detection signal when the first sampling signal of the power supply module 10 meets the first set condition; and the third component 23 may increase the voltage stabilization reference signal of the power supply module 10 when receiving the first detection signal.

In one embodiment, the first component may include a first comparator, and the third component may include an adder. The present disclosure does not limit this, and it may be configured according to actual needs.

In following, the first component including the first comparator and the third component including the adder will be used as an example to illustrate the power supply circuit of the present disclosure.

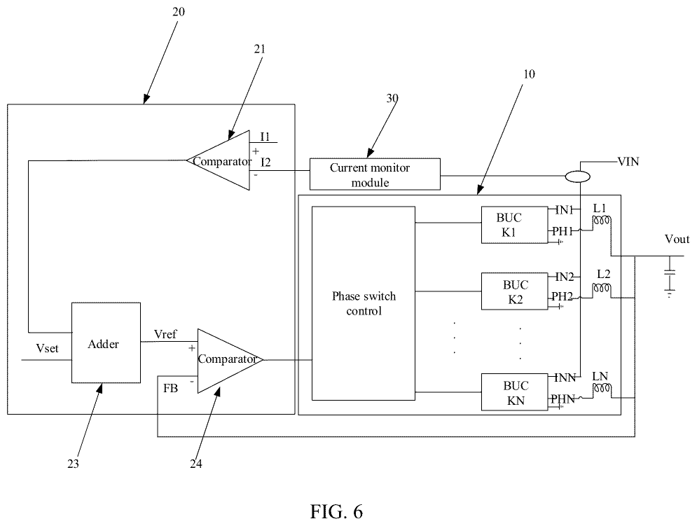

As shown in FIG. 6, the first component 21 obtains the output current I2 of the power supply module 10, compares the output current I2 with the first current I1, and outputs the first detection signal to the third component 23 when the output current I2 is less than the first current I1. The third component 23 responds to the first detection signal, increases the voltage ΔV on the basis of the voltage stabilization reference signal Vset, and outputs Vref to the power supply module 10.

In one embodiment, as shown in FIG. 6, the power supply circuit also includes a current monitor module 30, and the detection unit obtains the output current of the power supply module through the current monitor module 30. The present disclosure does not limit this, and it may be configured according to actual needs.

In one embodiment, as shown in FIG. 6, the controller also includes a fourth component 24. The fourth component 24 may include a second comparator. In this embodiment, the first input terminal of the second comparator may be connected to the output terminal of the third component 23, the second input terminal may be connected to the output terminal of the power supply module, and the output terminal may be connected to the power supply module, to control the power supply module to adjust the output voltage based on the output voltage signal of the third component and the output voltage of the power supply module. The present disclosure does not limit this, and it may be configured according to actual needs.

When the load of the power supply module switches from a small load to a large load, the output current of the power supply module may need to be adjusted from a small current to a large current, and the output capacitor electrically connected to the output terminal of the power supply module may release electricity, causing the voltage at the output terminal of the power supply module to decrease. When this time is maintained longer, the voltage drop at the output terminal of the power supply module may be larger, and the probability of causing system abnormality may be larger.

When the power supply circuit is working in the multi-phase state, the time required for switching between different numbers of output branches in the working state, such switching from two output branches in the working state to three output branches in the working state in the power supply module, or switching from three output branches in the working state to four output branches in the working state, may be short, and the probability of causing system abnormality in this process may be small. When the power supply circuit is switched from the multi-phase working state to the single-phase working state, that is, the moment shown in the dotted box in FIG. 1, the time required may be long, and the probability of causing system abnormality may be high.

At the transient state when the power supply module switches from the multi-phase working state to the single-phase working state, when the load of the power supply module suddenly increases, the current required by the load may suddenly increase. At this time, because of the slow loop response speed, the power supply module may continue to switch to the single-phase working state. After the switch to the single-phase working state finishes, it may switch from the single-phase working state to the multi-phase working state, increasing its output current, which takes a long time. The transient drop of the output voltage of the power supply module may be large.

Table 1 shows the combined scenario of the working state of the power supply module and the number of its working phases and the output voltage change amplitude under this scenario.

TABLE 1

| | | Number of working phases | |
|---|---|---|---|
| Working state | | Multi-phase working | Single-phase working |
| Load | Large current | Change amplitude of | No such scenario |
| | load | output voltage is small | |
| | Small current | Change amplitude of | Change amplitude |
| | load | output voltage may be | of output voltage |
| | | large | is small |

In one embodiment of the present disclosure, the detection unit may also be used to obtain a second sampling signal of the power supply module, and the second sampling signal may represent the working state of the power supply module. When the first sampling signal satisfies the first set condition and the second sampling signal satisfies the second set condition, the detection unit may output the first detection signal to further reduce the adjustment frequency of the output voltage of the power supply module on the basis of reducing the probability of system abnormality caused by the drop of the output voltage of the power supply circuit and improving the stability of the system operation.

In one embodiment of the present disclosure, the second set condition may represent that the power supply module is in the process of switching from the multi-phase state to the single-phase state. When the power supply module is controlled to increase the output voltage when the working state of the power supply module starts to switch to the single-phase working state, the response time of the adjustment of the output voltage of the power supply module may be larger than the time required for the working state of the power supply module to start switching to the single-phase working state, such that the output voltage of the power supply module may have a significant drop before it increases.

Therefore, in one embodiment of the present disclosure, the second set condition may indicate that the power supply module is in the first state. When the power supply module is in the first state, at least two of the multiple output branches may output drive signals, that is, the second set condition may indicate that the power supply module is in the multi-phase working state. Therefore, when the current working state of the power supply module is in the multi-phase working state and the output current of the power supply module is less than the threshold current when the first state is switched to the second state, the power supply module may be controlled to increase the output voltage, reducing the drop amplitude of the output voltage of the power supply circuit when the power supply module switches from the first state to the second state, reducing the probability of system abnormality caused by the drop of the output voltage of the power supply circuit, and improving the stability of system operation.

Optionally, based on the above embodiments, in another embodiment of the present disclosure, when the power supply module is in the second state, only one output branch of the power supply module may be in the working state, that is, the power supply module may be in the single-phase state. The first current may be the threshold current for the power supply module to switch from the multi-phase state to the single-phase state. It should be noted that in this embodiment, the output current of the power supply module may be less than the threshold current for the power supply module to switch from the multi-phase state to the single-phase state, which may indicate that the current load of the power supply module is small.

It should also be noted that when the first sampling signal satisfies the first set condition and the second sampling signal satisfies the second set condition, that is, when the current load of the power supply module is the small load and the power supply module is in the multi-phase state, after the controller controls the power supply module to increase the output voltage, the power supply module may encounter a scenario where the load is switched to a large load, or it may be a scenario where the load is maintained at a small load.

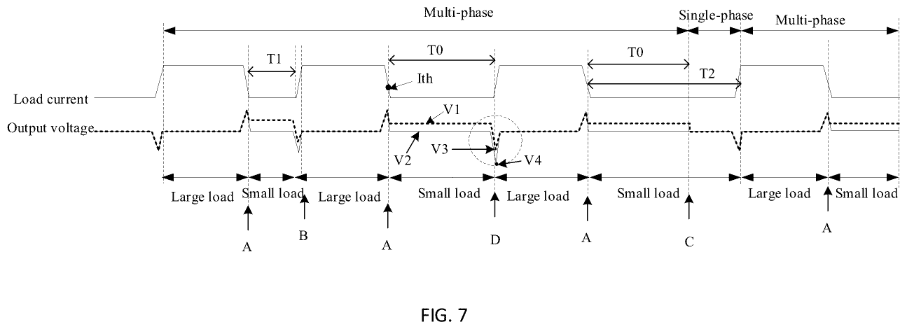

As shown in FIG. 7, which is a schematic diagram of the change of load current and the corresponding change curve of output voltage during the operation of the power supply circuit, T0 is the critical time for the power supply module to switch from the multi-phase working state to the single-phase working state, that is, the time required for the power supply module to complete the process of switching from the multi-phase working state to the single-phase working state is T0, T1<T0<T2. The dotted waveform in FIG. 7 is a schematic diagram of the output voltage of the power supply circuit provided by the present disclosure and the solid waveform is a schematic diagram of the output voltage of a power supply circuit in existing technologies. It can be seen from FIG. 7 that when the working state of the power supply module is currently in the multi-phase state and the load current of the power supply module is less than the threshold current Iₜₕ for switching from the multi-phase state to the single-phase state, the controller may control the power supply module to increase the output voltage, corresponding to the time A in FIG. 7. For convenience of description, the voltage after the controller controls the power supply module to increase the output voltage is recorded as the first voltage V1, and the voltage when the controller does not control the power supply module to increase the output voltage is recorded as the second voltage V2; when the power supply module is in a transient state of switching from the multi-phase to the single-phase and the load of the power supply module suddenly increases, the voltage of the power supply module after the drop is the third voltage V3; before the controller does not control the power supply module to increase the output voltage, when the power supply module is in a transient state of switching from the multi-phase to the single-phase and the load of the power supply module suddenly increases, the voltage of the power supply module after the drop is V4.

As shown in FIG. 7, when the load of the power supply module suddenly increases at the transient moment that the power supply module is switched from the multi-phase to the single-phase, compared with the voltage V4 after the power supply module drops from V2 before the output voltage of the power supply module increases, the voltage V3 after the power supply module drops from V1 after the output voltage of the power supply module increases is larger, which may reduce the difference between the output voltage V3 after dropping from the increased output voltage V1 and the output voltage V2 before the increase, that is, reduce the difference between the second voltage V2 and the third voltage V3, thereby reducing the variation amplitude of the output voltage of the power supply module, improving the stability of the output voltage of the power supply module, and reducing the probability of system abnormality caused by the large variation amplitude of the output voltage of the power supply module.

It should be noted that, when the output voltage of the power supply module increases, if the power supply module has not switched to the single-phase state, that is, within T1 time after the output voltage of the power supply module increases where T1 is less than T0, the load of the power supply module becomes larger, and the corresponding load current may be larger than the threshold current for switching from the multi-phase state to the single-phase state, the power supply module may no longer meet the first set condition, and the controller may no longer control the power supply module to increase the output voltage, and the output voltage of the power supply module may return to the voltage value V2 before adjustment, corresponding to the moment B in FIG. 7. When the output voltage of the power supply module increases, if the power supply module has switched to the single-phase state, thereafter, regardless of whether the load of the power supply module changes, the power supply module may no longer meet the second set condition, the controller may no longer control the power supply modules to increase the output voltage, and the output voltage of the power supply module may returns to the voltage value V2 before adjustment. When the load of the power supply module increases at time T2 after the output voltage of the power supply module increases, where T2>T0, the power supply module may switch to the single-phase state at T0 after the output voltage of the power supply module increases. At this time, the power supply module may no longer meet the second set condition. Therefore, at T0 after the output voltage of the power supply module increases, the controller may no longer control the power supply module to increase the output voltage, and the output voltage of the power supply module may return to the voltage value V2 before adjustment, corresponding to the moment C in FIG. 7.

The power supply circuit provided in the embodiment of the present disclosure may not only effectively alleviate the probability of system abnormality caused by the drop of the output voltage of the power supply circuit and improve the stability of the system operation, but also avoid the power consumption introduced when the output voltage of the power supply module is at a high voltage for a long time.

Based on any of the above embodiments, in another embodiment of the present disclosure, the adjustment unit may be used to increase the voltage stabilization reference signal of the power supply module when receiving the first detection signal, thereby controlling the power supply module to increase the output voltage by increasing the voltage stabilization reference signal of the power supply module. The present disclosure does not limit this, depending on the specific situation.

In one embodiment of the present disclosure, the detection unit may include a first component and a second component. The first component may output a second detection signal when the first sampling signal of the power supply module meets the first set condition; and the second component may output a first detection signal when the second detection signal output by the first component and the second sampling signal of the power supply module meet the second set condition.

The adjustment unit may include a third component, and the third component may be configured to increase the voltage stabilization reference signal of the power supply module when receiving the first detection signal.

Optionally, in one embodiment of the present disclosure, the first component may include a first comparator, the second component may include an AND gate, and the third component may include an adder. The present disclosure does not limit this and it depends on the specific situation.

The following describes the power supply circuit provided in the embodiment of the present disclosure, assuming that the first component includes a first comparator, the second component includes an AND gate, and the third component includes an adder.

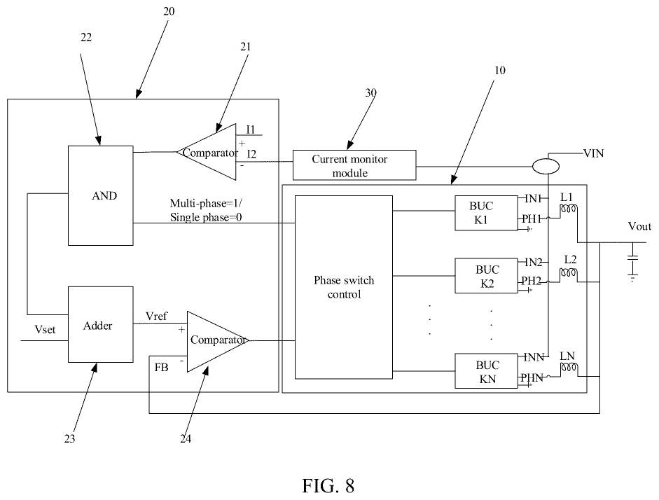

As shown in FIG. 8, in this embodiment, when the power supply module works in the multi-phase state, the second setting signal output to the first component is 1. When the power supply module works in a single-phase state, the second setting signal output to the first component is 0. The first component 21 obtains the output current I2 of the power supply module 10, compares the output current I2 with the first current I1, outputs the second detection signal to the second component 22 when the output current I2 is less than the first current I1, and outputs a first detection signal to the third component 23 when the second component 22 receives the second detection signal and the second setting signal is 1. The third component 23 responds to the first detection signal, increases the voltage ΔV on the basis of the voltage stabilization reference signal Vset, and outputs Vref to the power supply module 10.

In one embodiment of the present disclosure, as shown in FIG. 8, the power supply circuit further includes a current monitor module 30, and the detection unit obtains the output current of the power supply module through the current monitor module 30. The present disclosure does not limit this, depending on the specific situation.

Optionally, in one embodiment of the present disclosure, as shown in FIG. 8, the controller further includes a fourth component 24, and the fourth component 24 may include a second comparator. In this embodiment, the first input terminal of the second comparator may be connected to the output terminal of the third component 23, the second input terminal may be connected to the output terminal of the power supply module, and the output terminal may be connected to the power supply module, to control the power supply module to adjust the output voltage based on the output voltage signal of the third component and the output voltage of the power supply module. The present disclosure does not limit this, depending on the specific situation.

One embodiment of the present disclosure also provides a chip and an electronic device including the chip. The chip may include the power supply circuit provided by any of the above embodiments. The electronic device may be various devices such as mobile phones and computers, and the present disclosure does not limit this, depending on the specific situation.

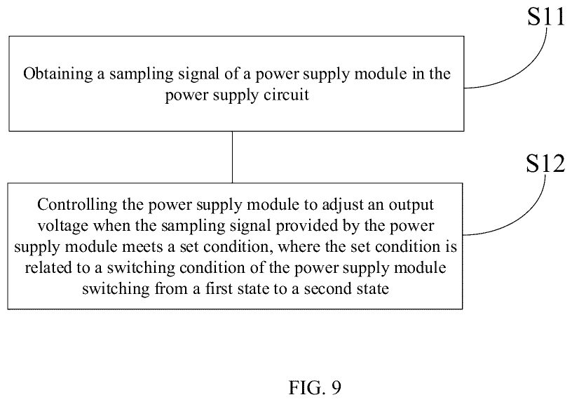

The present disclosure also provides a control method, which is applied to a power supply circuit provided by any of the above embodiments. As shown in FIG. 9, in one embodiment, the control method includes:

S11: obtaining a sampling signal of the power supply module in the power supply circuit; and

S12: when the sampling signal provided by the power supply module in the power supply circuit meets the set condition, controlling the power supply module to adjust the output voltage, where the set condition is related to the switching condition of the power supply module switching from the first state to the second state.

The control method provided by the embodiments of the present disclosure may control the power supply module to adjust the output voltage based on the set condition related to the switching condition of the power supply module switching from the first state to the second state, such that, when the power supply module switches from the first state to the second state, the output voltage of the power supply module changes less, avoiding the phenomenon of large transient voltage changes in the output voltage of the power supply module, improving the stability of the output voltage of the power supply circuit, and thus reducing the probability of system abnormalities in the equipment powered by the power supply circuit when working.

Optionally, in one embodiment of the present disclosure, obtaining the sampling signal of the power supply module in the power supply circuit may include: obtaining the first sampling signal of the power supply module in the power supply circuit. Correspondingly, when the sampling signal provided by the power supply module in the power supply circuit meets the set condition, controlling the power supply module to adjust the output voltage may include: when the first sampling signal provided by the power supply module in the power supply circuit meets the first set condition, controlling the power supply module to increase the output voltage, where the first sampling signal is related to the output current of the power supply module.

In the embodiment of the present disclosure, the control method may control the power supply module to increase the output voltage based on the first sampling signal related to the output current of the power supply module. Therefore, when the output current provided by the power supply circuit needs to switch from a small current to a large current, the output voltage drop of the power supply circuit may be reduced, the probability of the output voltage drop of the power supply circuit causing system abnormality may be reduced, the stability of the system operation may be improved, and the adjustment frequency of the output voltage of the power supply module may be reduced.

In one embodiment of the present embodiment, the first sampling signal may be the output current of the power supply module, the first set condition may include that the first sampling signal is less than the first current, and the first current may be the threshold current when the power supply module switches from the first state to the second state. Therefore, when the output current of the power supply module is less than the threshold current when the power supply module switches from the first state to the second state, the control method may control the power supply module to increase the output voltage and reduce the regulation frequency of the output voltage of the power supply module, thereby reducing the regulation frequency of the output voltage of the power supply module and reducing the power consumption of the power supply circuit on the basis of reducing the probability of system abnormality caused by the drop of the output voltage of the power supply module. The present disclosure does not limit this and it depends on the specific situation.

In another embodiment of the present disclosure, obtaining the sampling signal of the power supply module in the power supply circuit may further include: obtaining the second sampling signal of the power supply module in the power supply circuit. Correspondingly, when the sampling signal provided by the power supply module in the power supply circuit meets the set condition, controlling the power supply module to adjust the output voltage may include: when the first sampling signal provided by the power supply module in the power supply circuit meets the first set condition and the second sampling signal provided by the power supply module in the power supply circuit meets the second set condition, controlling the power supply module to increase the output voltage. The first sampling signal may be related to the output current of the power supply module, and the second sampling signal may represent the working state of the power supply module.

Optionally, in one embodiment of the present disclosure, the second set condition may represent that the power supply module is in the process of switching from the multi-phase state to the single-phase state. When the power supply module is controlled to increase the output voltage when the working state of the power supply module starts to switch to the single-phase working state, the response time of the output voltage adjustment of the power supply module may be larger than the time required for the working state of the power supply module to start switching to the single-phase working state, such that the output voltage of the power supply module may have a significant drop before it increases.

Therefore, in one embodiment of the present disclosure, the second set condition may indicate that the power supply module is in the first state. When the power supply module is in the first state, at least two of the multiple output branches may output drive signals, that is, the power supply module may be in the multi-phase working state. Therefore, when the current working state of the power supply module is in the multi-phase working state and the output current of the power supply module is less than the threshold current at the moment of the first state switching to the second state, the power supply module may be controlled to increase the output voltage, reducing the drop amplitude of the output voltage of the power supply circuit when the power supply module switches from the first state to the second state, reducing the probability of system abnormality caused by the drop of the output voltage of the power supply circuit, and improving the stability of system operation.

Optionally, based on the above embodiments, in one embodiment of the present disclosure, when the power supply module is in the second state, only one output branch of the power supply module may be in the working state, that is, the power supply module may be in the single-phase state. The first current may be the threshold current for the power supply module to switch from the multi-phase state to the single-phase state. It should be noted that in this embodiment, the output current of the power supply module may be less than the threshold current for the power supply module to switch from the multi-phase state to the single-phase state, which indicates that the current load of the power supply module is small.

On the basis of any of the above embodiments, in one embodiment of the present disclosure, controlling the power supply module to adjust the output voltage may include: increasing the voltage stabilization reference signal of the power supply module to control the power supply module to increase the output voltage, thereby controlling the power supply module to increase the output voltage by increasing the voltage stabilization reference signal of the power supply module. The present disclosure does not limit this, and it depends on the specific situation.

It should be noted that when the first sampling signal satisfies the first set condition and the second sampling signal satisfies the second set condition, that is, when the current load of the power supply module is a small load and the power supply module is in the multi-phase state, after the control method controls the power supply module to increase the output voltage, the power supply module may encounter a scenario where the load is switched to a large load, or a scenario where the load is maintained to be a small load.

An exemplary embodiment will be used to describe the control method bellow.

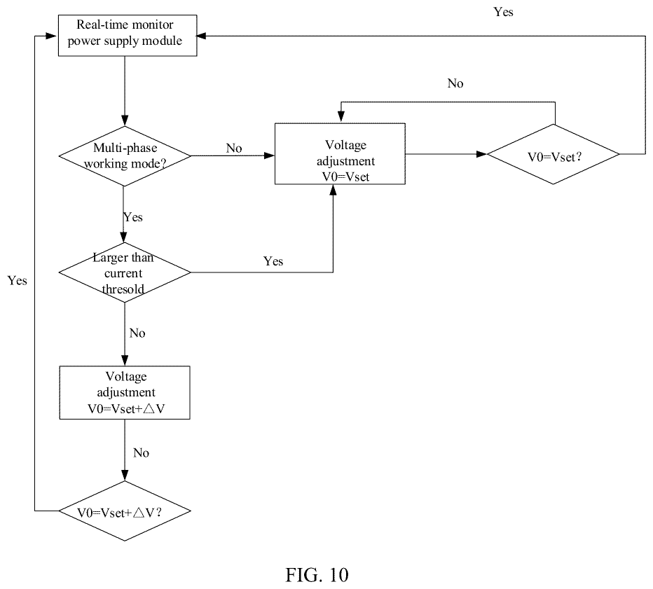

As shown in FIG. 10, in this embodiment, the control method includes:
S21: monitoring the power supply module of the power supply circuit and obtaining the sampling signal of the power supply module, where the monitoring of the power supply module of the power supply circuit is performed in real-time or at a preset frequency, which is not limited in this disclosure and depends on the specific situation;
S22: determining whether the power supply module is in the multi-phase working state based on the second sampling signal of the power supply module;
S23: when the power supply module is in the multi-phase working state, determining whether the output current of the power supply module is less than the threshold current for the power supply module to switch from the first state to the second state based on the first sampling signal of the power supply module; and, when the power supply module is not in the multi-phase working state, controlling the voltage stabilization reference signal V0 of the power supply module to be the first voltage stabilization reference signal Vset; and
S24: when the output current of the power supply module is less than the threshold current for the power supply module to switch from the first state to the second state, increasing the voltage stabilization reference signal V0 of the power supply module to the second voltage stabilization reference signal Vset+ΔV, thereby increasing the output voltage of the power supply module, and returning to execute S21.

It should be noted that in the above embodiment, V0 represents the actual digital logic voltage in the power supply circuit; Vset represents the digital voltage configured by the register in the power supply circuit. Optionally, the value range of Vset may be 0˜1.5V. In some application scenarios, the value range of Vset may be 50 mV˜100 mV. The present disclosure does not limit this, depending on the specific situation. ΔV represents the set voltage adjustment amplitude. The threshold current for the power supply module to switch from the first state to the second state is a preset value, and its specific value depends on the chip used by the power supply circuit.

In one embodiment of the present disclosure, when the power supply module is not in the multi-phase working state, controlling the voltage stabilization reference signal V0 of the power supply module to be the first voltage stabilization reference signal Vset may include: when the power supply module is not in the multi-phase working state, determining whether the current voltage stabilization reference signal V0 of the power supply module is the first voltage stabilization reference signal Vset; when the power supply module is not in the multi-phase working state and the current voltage stabilization reference signal V0 of the power supply module is the first voltage stabilization reference signal Vset, maintaining the voltage stabilization reference signal of the power supply module unchanged; and, when the power supply module is not in the multi-phase working state and the current voltage stabilization reference signal V0 of the power supply module is not the first voltage stabilization reference signal Vset, adjusting the voltage stabilization reference signal of the power supply module until the voltage stabilization reference signal of the power supply module is the first voltage stabilization reference signal Vset.

It should be noted that the above embodiment is described by taking the control method in which the second set condition is first determined and then the first set condition is determined, as an example. The present disclosure does not limit this. In other embodiments of the present disclosure, the control method may also first determine the first set condition and then the second set condition, or perform the first set condition and the second set condition determination in parallel, depending on the specific situation.

As such, the control method provided in the embodiments of the present disclosure may adjust the output voltage of the power supply module based on the set conditions related to the switching conditions of the power supply module switching from the first state to the second state, such that when the power supply module switches from the first state to the second state, the output voltage of the power supply module may change less, avoiding the phenomenon that the output voltage of the power supply module has a large transient voltage change, improving the stability of the output voltage of the power supply circuit, and thus reducing the probability of system abnormality when the device powered by the power supply circuit is working.

In the present disclosure, each embodiment is described in a progressive, parallel, or progressive and parallel manner. Each embodiment focuses on the differences from other embodiments, and the same or similar parts between the embodiments can be referred to each other. For the device disclosed in the embodiments, since it corresponds to the method disclosed in the embodiments, the description is relatively simple, and the relevant parts can be referred to the method part.

Various embodiments have been described to illustrate the operation principles and exemplary implementations. Those skilled in the art would understand that the present disclosure is not limited to the specific embodiments described herein and there can be various other changes, rearrangements, and substitutions. Thus, while the present disclosure has been described in detail with reference to the above described embodiments, the present disclosure is not limited to the above described embodiments, but may be embodied in other equivalent forms without departing from the spirit and scope of the present disclosure.

What is claimed is:

1. A power supply circuit, comprising:
a power supply module including a plurality of output branches configured to control a working state of each of the plurality of output branches according to a load, to provide a suitable driving signal; and
a controller connected to the power supply module and configured to control the power supply module to adjust an output voltage when a sampling signal provided by the power supply module meets a set condition, wherein the set condition is related to a switching condition of the power supply module switching from a first state to a second state.

2. The power supply circuit according to claim 1, wherein the controller includes:
a detection unit, configured to obtain a first sampling signal of the power supply module and output a first detection signal when the first sampling signal meets a first set condition, wherein the first sampling signal is related to the output current of the power supply module; and
an adjustment unit, configured to: when receiving the first detection signal, control the power supply module to increase the output voltage.

3. The power supply circuit according to claim 2, wherein:
the first sampling signal is the output current of the power supply module, the first set condition is that the first sampling signal is less than a first current, and the first current is a threshold current when the power supply module switches from the first state to the second state.

4. The power supply circuit according to claim 2, wherein:
the detection unit is also configured to obtain a second sampling signal of the power supply module, wherein the second sampling signal represents the working state of the power supply module; and
the detection unit is configured to output the first detection signal when the first sampling signal meets the first set condition and the second sampling signal meets a second set condition.

5. The power supply circuit according to claim 4, wherein:
the second set condition indicates that the power supply module is in the first state, wherein: when the power supply module is in the first state, at least two of the plurality of output branches output drive signals.

6. The power supply circuit according to claim 2, wherein:
the adjustment unit is configured to increase a voltage stabilization reference signal of the power supply module when receiving the first detection signal.

7. The power supply circuit according to claim 6, wherein:
the detection unit includes: a first component and a second component, wherein:
the first component outputs the second detection signal when the first sampling signal of the power supply module meets the first set condition; the second component outputs the first detection signal when the first component outputs the second detection signal and the second sampling signal of the power supply module meets a second set condition; and
the adjustment unit includes: a third component, wherein the third component increases the voltage regulation reference signal of the power supply module when receiving the first detection signal.

8. A control method of a power supply circuit, comprising:
obtaining a sampling signal of a power supply module in the power supply circuit; and
controlling the power supply module to adjust an output voltage when the sampling signal provided by the power supply module meets a set condition, wherein the set condition is related to a switching condition of the power supply module switching from a first state to a second state.

9. The control method according to claim 8, wherein controlling the power supply module to adjust the output voltage includes:
when a first sampling signal provided by the power supply module in the power supply circuit meets a first set condition, controlling the power supply module to increase the output voltage, wherein the first sampling signal is related to the output current of the power supply module.

10. The control method according to claim 8, wherein controlling the power supply module to adjust the output voltage includes:
when a first sampling signal provided by the power supply module in the power supply circuit meets a first set condition and a second sampling signal provided by the power supply module in the power supply circuit meets a second set condition, controlling the power supply module to increase the output voltage, wherein the first sampling signal is related to the output current of the power supply module and the second sampling signal represents the working state of the power supply module.

11. The control method according to claim 10, wherein:
the second set condition indicates that the power supply module is in the first state, wherein: when the power supply module is in the first state, at least two of the plurality of output branches output drive signals.

12. The control method according to claim 8, further comprising:
increasing a voltage stabilization reference signal of the power supply module when receiving a first detection signal.

13. A chip, comprising a power supply circuit, wherein:
the power supply circuit includes:
a power supply module including a plurality of output branches configured to control a working state of each of the plurality of output branches according to a load to provide a suitable driving signal; and
a controller connected to the power supply module and configured to control the power supply module to adjust an output voltage when a sampling signal provided by the power supply module meets a set condition, wherein the set condition is related to a switching condition of the power supply module switching from a first state to a second state.

14. The chip according to claim 13, wherein the controller includes:
a detection unit, configured to obtain a first sampling signal of the power supply module and output a first detection signal when the first sampling signal meets a first set condition, wherein the first sampling signal is related to the output current of the power supply module; and
an adjustment unit, configured to: when receiving the first detection signal, control the power supply module to increase the output voltage.

15. The chip according to claim 14, wherein:
the first sampling signal is the output current of the power supply module, the first set condition is that the first sampling signal is less than a first current, and the first current is a threshold current when the power supply module switches from the first state to the second state.

16. The chip according to claim 14, wherein:
the detection unit is also configured to obtain a second sampling signal of the power supply module, wherein the second sampling signal represents the working state of the power supply module; and
the detection unit is configured to output the first detection signal when the first sampling signal meets the first set condition and the second sampling signal meets a second set condition.

17. The chip according to claim 16, wherein:
the second set condition indicates that the power supply module is in the first state, wherein: when the power supply module is in the first state, at least two of the plurality of output branches output drive signals.

18. The chip according to claim 14, wherein:
the adjustment unit is configured to increase a voltage stabilization reference signal of the power supply module when receiving the first detection signal.

19. The chip according to claim 18, wherein:
the detection unit includes: a first component and a second component, wherein:
the first component outputs the second detection signal when the first sampling signal of the power supply module meets the first set condition; the second component outputs the first detection signal when the first component outputs the second detection signal and the second sampling signal of the power supply module meets a second set condition; and
the adjustment unit includes: a third component, wherein the third component increases the voltage regulation reference signal of the power supply module when receiving the first detection signal.

20. An electronic device, comprising the chip according to claim 13.
